(19) United States
(12) Patent Application Publication
(10) Pub. No.: US 2008/0198251 A1
(43) Pub. Date: Aug. 21, 2008

(54) Method, apparatus, and system providing multiple pixel integration periods

(75) Inventor: Chen Xu, Boise, ID (US)

Correspondence Address: DICKSTEIN SHAPIRO LLP, 1825 EYE STREET, NW, WASHINGTON, DC, 20006, US

(73) Assignee: Micron Technology, Inc.

(21) Appl. No.: 11/706,227

(22) Filed: Feb. 15, 2007

(51) Int. Cl. H04N 3/14

(52) U.S. Cl. 348/297; 257/292

(57) ABSTRACT

A method, apparatus and system providing high dynamic range operation for an image sensor by using signals from multiple pixels having different integration times.

### FIELD OF THE INVENTION

Embodiments of the invention relate generally to imager devices, and more particularly to an imager pixel having an increased dynamic range.

### BACKGROUND

An imager, for example, a complementary metal oxide semiconductor (CMOS) imager, includes a focal plane array of pixels; each pixel includes a photosensor, for example, a photogate, photoconductor or a photodiode overlying a substrate for producing a photo-generated charge in a doped region of the substrate. A readout circuit is provided for each pixel and includes at least a source follower transistor and a row select transistor for coupling the source follower transistor to a column output line. The pixel also typically has a floating diffusion region, connected to the gate of the source follower transistor. Charge generated by the photosensor is sent to the floating diffusion region. The imager may also include a transistor for transferring charge from the photosensor to the floating diffusion region and another transistor for resetting the floating diffusion region to a predetermined charge level prior to charge transference.

FIG. 1 illustrates a block diagram of a CMOS imager 208 having a pixel array 200 with each pixel being constructed as described above. Pixel array 200 comprises a plurality of pixels arranged in a predetermined number of columns and rows. The pixels of each row in array 200 are all turned on at the same time by a row select line, and the pixels of each column are selectively output onto output lines by respective column select lines. A plurality of row and column select lines are provided for the entire array 200. The row lines are selectively activated in sequence by the row driver 210 in response to row address decoder 220 and the column select lines are selectively activated in sequence for each row activated by a column driver incorporated in the column address decoder 270. Thus, a row and column address is provided for each pixel.

The CMOS imager 208 is operated by the control circuit 250, which controls address decoders 220, 270 for selecting the appropriate row and column lines for pixel readout, and row and column driver circuitry 210, 260, which apply driving voltage to the drive transistors of the selected row and column lines. The pixel output signals typically include a pixel reset signal, Vrst, taken off the floating diffusion region when it is reset and a pixel image signal, Vsig, which is taken off the floating diffusion region after charges generated by an image are transferred to it. The Vrst and Vsig signals are read by a sample and hold circuit 265 and are subtracted by a differential amplifier 267 that produces a signal Vrst−Vsig for each pixel, which represents the amount of light impinging on the pixel. This difference signal is digitized by an analog to digital converter 275. The digitized pixel signals are then fed to an image processor 280 to form and output a digital image. The digitizing and image processing can be performed on or off the chip containing the pixel array.

Imagers, such as an imager employing the conventional pixels described above, as well as imagers employing other pixel architectures, have a characteristic light dynamic range. Light dynamic range refers to the range of incident light that can be accommodated by an imager in a single frame of pixel data. It is desirable to have an imager with a high light dynamic range to image scenes that generate high light dynamic range incident signals, such as indoor rooms with windows to the outside, outdoor scenes with mixed shadows and bright sunshine, night-time scenes combining artificial lighting and shadows, and many others.

When the light dynamic range of an imager is too small to accommodate the variations in light intensities of the imaged scene, e.g., by having a low light saturation level, the full range of the image scene is not sensed and cannot be reproduced.

In addition, if the incident light captured and converted into a charge by the photosensor during an integration period is greater than the capacity of the photosensor, excess charge may overflow and be transferred to adjacent pixels. This undesirable phenomenon is known as blooming, or charge cross talk, and can result in a bright spot in the output image.

Imager pixels, including CMOS imager pixels, typically have low signal-to-noise ratios and narrow dynamic range because of their inability to fully collect, transfer, and store the full extent of electric charge generated by the photosensitive area of the pixel photosensor. Since the amplitude of the electrical signals generated by any given pixel in a CMOS imager is very small, it is especially important for the signal-to-noise ratio and dynamic range of the pixel to be as high as possible. Generally speaking, these desired features are not attainable without additional photoconversion area or additional devices that increase the size of the pixel circuitry. Therefore, there is a need for an improved pixel for use in an imager that provides high signal to noise ratio and high dynamic range while maintaining a small pixel size.

### BRIEF DESCRIPTION OF THE DRAWINGS

FIG. 1 is a block diagram of a conventional CMOS imager.

FIG. 2 is schematic diagram of a conventional pixel.

FIG. 3 is block diagram of a pixel array configured to provide multiple integration periods.

FIG. 4 is an example circuit diagram of a portion of a pixel array configured to provide up to two integration periods.

FIG. 5 is an example timing diagram of a rolling shutter readout of the pixel array of FIG. 4.

FIG. 6 is an example circuit diagram of a portion of a pixel array configured to provide up to four integration periods.

FIG. 7 is an example timing diagram of a rolling shutter readout of the pixel array of FIG. 6.

FIG. 8 is an example circuit diagram of a five-transistor anti-blooming pixel.

FIG. 9 is an example circuit diagram of a portion of an anti-blooming pixel array configured to provide up to two integration periods.

FIG. 10 is an example timing diagram of a global shutter readout of the pixel array of FIG. 9.

FIG. 11 is an example circuit diagram of a portion of an anti-blooming pixel array configured to provide up to four integration periods.

FIG. 12 is an example timing diagram of a global shutter readout of the pixel array of FIG. 11.

FIG. 13 is an example camera processor system incorporating at least one imaging device constructed in accordance with an embodiment of the disclosure

### DETAILED DESCRIPTION OF THE INVENTION

In the following detailed description, reference is made to the accompanying drawings, which form a part hereof and illustrate specific embodiments in which the invention may be practiced. In the drawings, like reference numerals describe substantially similar components throughout the several views. These embodiments are described in sufficient detail to enable those skilled in the art to practice them, and it is to be understood that other embodiments may be utilized, and that structural, logical and electrical changes may be made.

The term “pixel” refers to a picture element unit cell containing a photosensor and other devices for converting electromagnetic radiation to an electrical signal. For purposes of illustration, a representative pixel is illustrated in the figures and description herein, and typically fabrication of all pixels in a pixel array will proceed simultaneously in a similar fashion.

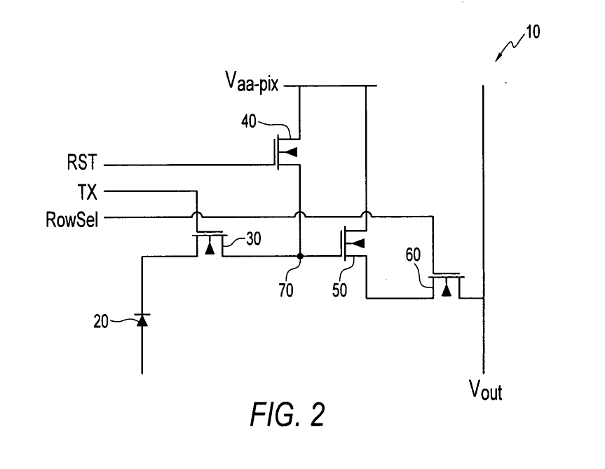

Referring now to the drawings, where like elements are designated by like reference numerals, FIG. 2 shows a conventional four-transistor pixel, including a photosensor 20, e.g., a pinned photodiode, a transfer transistor 30, reset transistor 40, source follower transistor 50, row select transistor 60, a storage region 70, and an output column line Vout. The photosensor 20 is connected to a source/drain terminal of the transfer transistor 30. The state of the transfer transistor 30 is controlled by a signal line TX. While the transfer transistor is in the “off” state, charge generated from light impinging upon the photosensor 20 accumulates within the photosensor 20. When the transfer transistor 30 is switched to the “on” state, the accumulated charge in the photosensor 20 is transferred to the storage region 70 and the photosensor 20 is simultaneously reset. The storage region 70 is connected to a gate of the source follower transistor 50. The source follower transistor 50 receives power from the Vaa-pix line and amplifies the signal received from the storage region 70 for readout. The pixel 10 is selected for readout by a RowSel signal, which controls the row select transistor 60. When the row select transistor 60 is switched to the “on” state, the amplified signal from the source follower transistor 50 is transferred to the output column line Vout. The storage region 70 may then be reset to a known voltage by the reset transistor 40 in preparation for a readout sequence, such as correlated double sampling.

The time period during which photogenerated charge accumulates in the photosensor 20 is referred to as an integration period. The integration period begins when charge starts to accumulate in the photosensor 20 and ends when the transfer transistor 30 is switched to the “on” state and the accumulated charge is transferred from the photosensor 20 to the storage region 70. The timing of the transfer of charge from the photosensor 20 to the storage region 70 is controlled by the transfer transistor 30, therefore the length of the integration period may be controlled by the timing of operation of the transfer transistor 30.

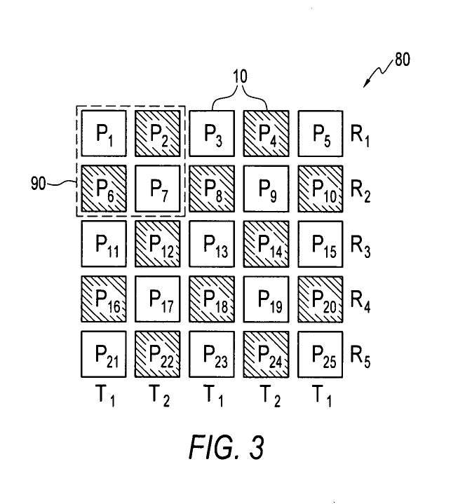

In a conventional pixel array the TX, RST and RowSel signal lines are shared by pixels in a single row. Accordingly, all pixels in a row having a common TX line accumulate charge for a common integration period. FIG. 3 shows an embodiment of a section of a pixel array 80 wherein pixels 10 in each row do not share a common TX line and do not accumulate charge for a common integration period. The non-shaded pixels, for example P1, P3, and P5, are controlled by a first TX line (not shown) and are operated to accumulate charge for a first integration period T1 while the shaded pixels, for example P2, P4, and P6, are controlled by a second TX line (not shown) and are operated to accumulate charge for a second integration period T2. Accordingly, up to two different integration periods may be provided.

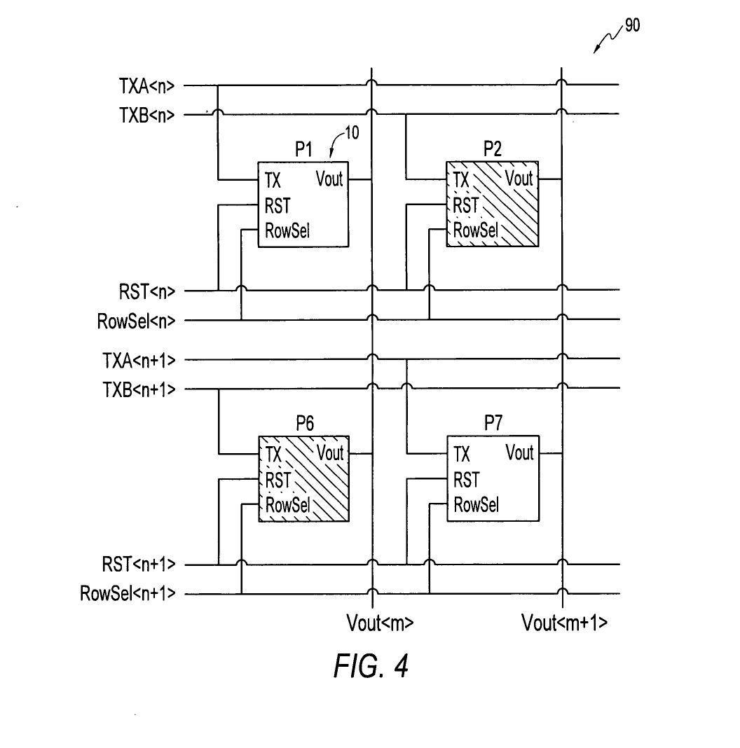

FIG. 4 shows a portion 90 of the embodiment of FIG. 3, illustrating transfer signal lines TXA and TXB configured to provide two integration periods, T1 and T2 to pixels in a checker-board pattern as shown in FIG. 3. Pixels P1 and P7 are operated by transfer signal lines TXA<n> and TXA<n+1>, respectively. Pixels P2 and P6 are operated by transfer signal lines TXB<n> and TXB<n+1>, respectively.

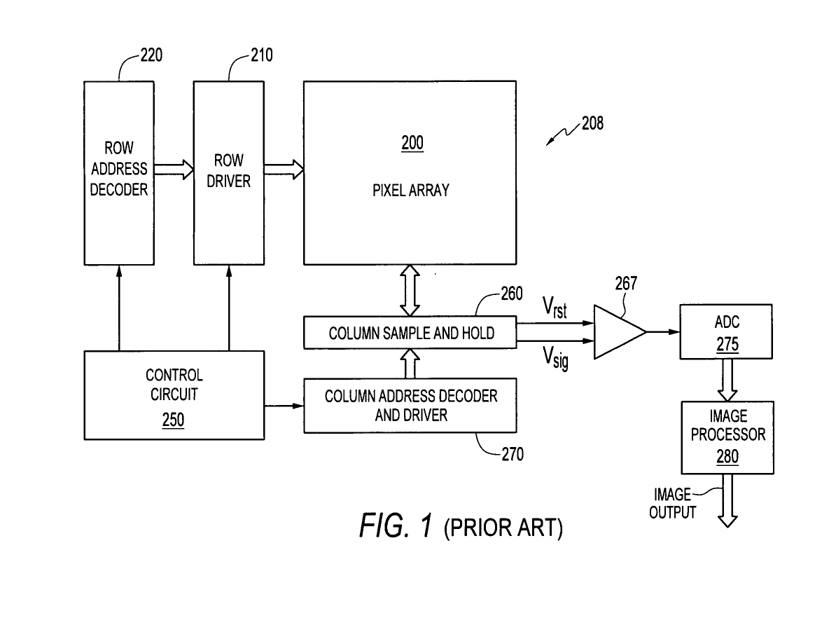

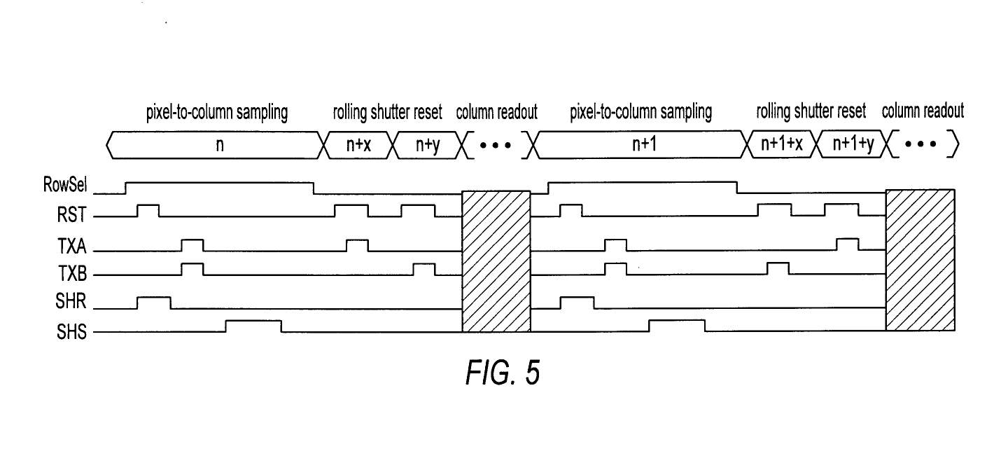

FIG. 5 is an example timing diagram for the operation of a pixel array 80 having transfer signal lines TXA and TXB as shown in FIG. 4. The embodiment uses a rolling shutter readout and correlated double sampling (CDS), which is a readout technique comprising first sampling a reset value, then a sampling signal value, and subtracting the sampled signal value from the sampled reset value to obtain an output having common noise removed. The readout of the pixel array 80 may be accomplished by modifying the array readout circuitry illustrated in FIG. 1 using the timing and signals discussed below, and with reference to a four transistor circuit as illustrated in FIG. 2, with pixels in the array rows arranged in exclusive subsets as described above with reference to FIG. 3 and FIG. 4.

Referring to FIG. 5, first row(n) is selected for pixel-to-column readout by sampling of currently stored charge on storage region 70 by pulsing and maintaining a voltage on RowSel line (n). The storage region 70 of pixels in row(n) is then reset by a pulse on RST line (n). The reset charge on storage region 70 is sampled next by a pulse on the SHR line. This sampling causes a reset signal Vrst to be placed on a sampling capacitor in sample and hold circuit 265 (FIG. 1). Subsequently, a signal is pulsed on both transfer signal lines TXA(n) and TXB(n) simultaneously to transfer currently stored charge from the photosensors 20 of the row pixels to the storage regions 70 of all pixels of row(n). A sampling of the transferred charge for each pixel is executed by an SHS pulse. This sampling causes a photogenerated signal Vsig to be placed on a sampling capacitor in sample and hold circuit 265. The sampled signals are then subtracted in differential amplifier 267 and the readout digitized by analog to digital converter 275.

Next, pulses on RST lines (n+x) and (n+y) initiate a rolling shutter reset of two subsequent rows, (n+x) and (n+y). While RST line (n+x) is high, photosensors 20 of pixels 10 connected to TXA line (n+x) are reset by a pulse on TXA line (n+x) which operates transfer transistor 30 (FIG. 2) coupled to TXA and couples photosensor 20 to the reset voltage. Charge accumulation in the photosensors 20 of pixels 10 in row (n+x) connected to TXA begins in the pixels when RST line (n+x) and TXA line (n+x) drop back to low. Next, RST line (n+y) is pulsed high. While RST line (n+y) is high, photosensors 20 of pixels 10 connected to TXB line (n+y) are reset by a pulse on TXB line (n+y). Charge accumulation begins in the pixels when RST line (n+y) and TXB line (n+y) drop back to a low value. The difference in time between the pulse on TXA line (n+x) and the pulse on TXB line (n+y) provides differing integration times for the pixels in rows (n+x) connected to TXA and pixels in row (n+y) connected to TXB controlled by the respective transfer lines, as previously described.

Following the initiation of charge accumulation in subsequent rows (n+x) and (n+y), the readout sequence moves to row (n+1). The pixels in row (n+1) connected to the TXA line have been integrating charge longer than the pixels in row (n+y) which are connected to the TXB line and the readout process described above for row (n) is now repeated for row (n+1). Row (n+1) is selected for pixel-to-column sampling by pulsing and maintaining a voltage on RowSel line (n+1). The storage regions 70 of pixels in row (n+1) are then reset by a pulse on RST line (n+1). The reset charge on storage regions 70 are sampled next, the sampling being executed by a pulse on the SHR line. Next, a signal is pulsed on both transfer signal lines TXA(n+1) and TXB(n+1) simultaneously to transfer accumulated charge from the photosensor 20 to the storage region 70. A sampling of the transferred charge is executed by a SHS pulse.

Similarly, pulses on RST lines (n+1+x) and (n+1+y) initiate a rolling shutter reset in subsequent rows (n+1+x) and (n+1+y). However, the order of operation of transfer signals TXA and TXB are now reversed to provide the checker-board pattern of integration times shown in FIG. 3. While RST line (n+1+x) is high, photosensors 20 of pixels 10 connected to TXB line (n+1+x) are reset by a pulse on TXB line (n+1+x). RST line (n+1+x) and TXB line (n+1+x) drop back to a low value, and RST line (n+1+y) is pulsed high. While RST line (n+1+y) is high, photosensors 20 of pixels 10 connected to TXA line (n+1+y) are reset by a pulse on TXA line (n+y). RST line (n+1+y) and TXA line (n+1+y) subsequently drop back to a low value.

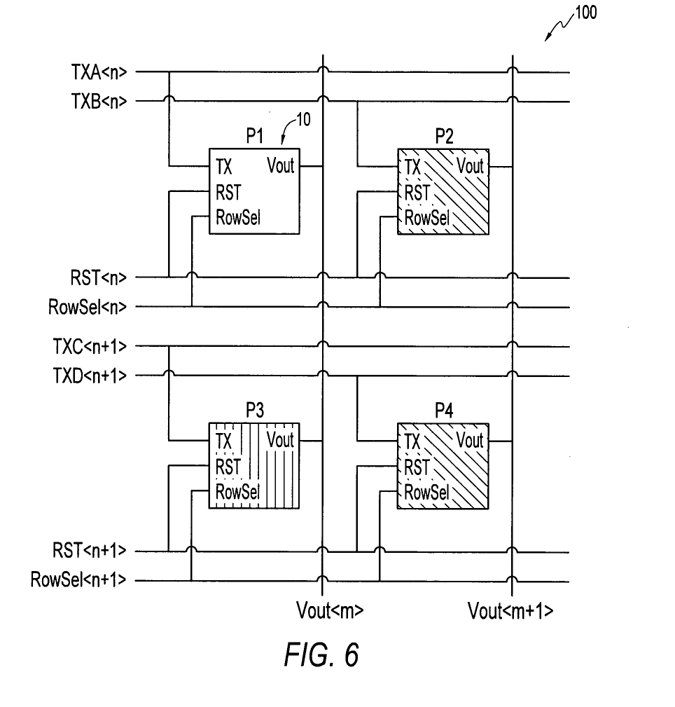

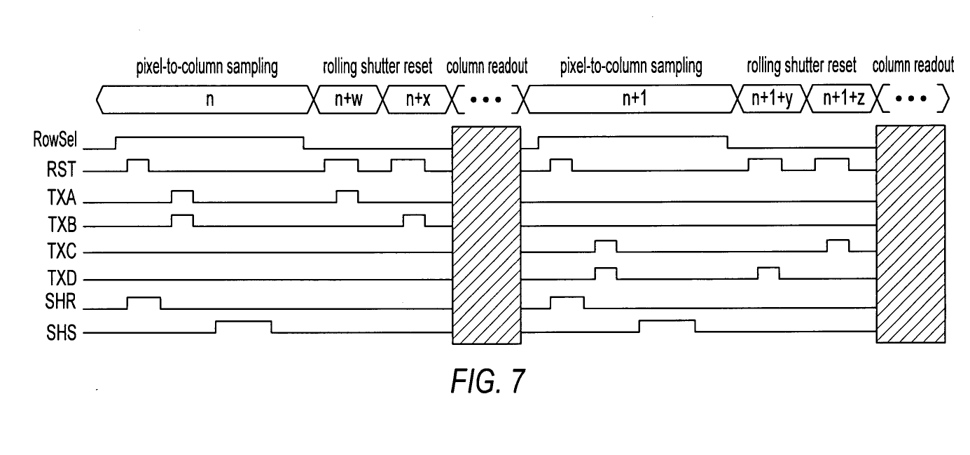

FIG. 6 shows an embodiment providing four integration times using four different transfer lines and pixels in two rows, e.g., (n), (n+1). Pixel P1 of row(n) is controlled by TXA, pixel P2 of row(n) is controlled by TXB, pixel P3 of row(n+1) is controlled by TXC and pixel P4 of row(n+1) is controlled by TXD. FIG. 7 shows an example timing diagram for the embodiment FIG. 6, operating similar to the timing diagram of FIG. 5 with the exception of the additional TXC and TXD transfer lines. A rolling shutter reset of rows (n+w), (n+x), (n+y+1) and (n+z+1) are implemented using signal lines TXA, TXB, TXC, and TXD in a manner similar to that as described above for FIG. 5.

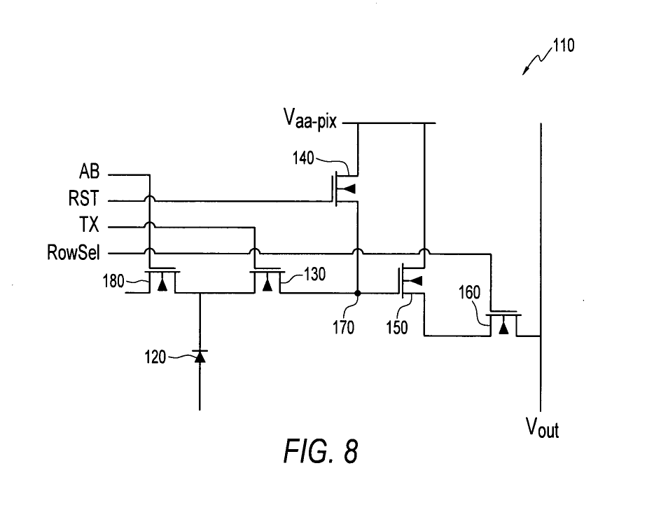

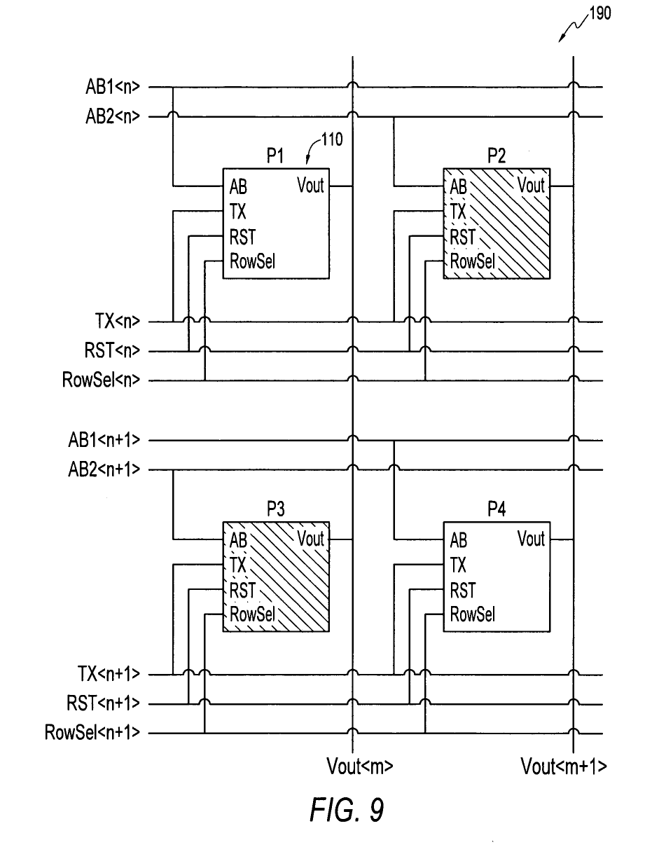

It should be understood that an array 80 providing multiple integration times in an integration configuration as shown in FIG. 3 may be achieved using different types of pixels and readout methods from those described above. FIG. 8 shows a five-transistor anti-blooming (AB) pixel 110, including a photosensor 120, e.g., a pinned photodiode, a transfer transistor 130, reset transistor 140, source follower transistor 150, row select transistor 160, a storage region 170, an anti-blooming transistor 180 and an output column line Vout. Similar to the four-transistor pixel 10 (FIG. 2), the AB pixel 110 may be configured as shown in the array subset 190 of FIG. 9 to support multiple integration times. Comparing the array subset 190 to array subset 90 of FIG. 4, the AB lines are operated to control photodiode integration times instead of the TX lines. Anti-blooming control line AB1 controls pixels P1 of row(n) and P4 of row(n+1) while anti-blooming control line AB2 controls pixels P2 of row(n) and P3 of row(n+1).

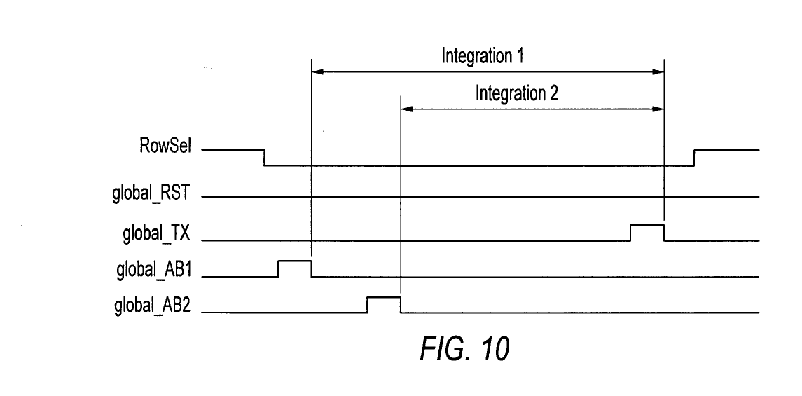

FIG. 10 shows a timing diagram for operating the AB pixel 110 configuration of FIG. 9 to provide multiple integration periods. The timing diagram of FIG. 10 executes a global shutter readout instead of the rolling shutter readout described in FIGS. 5 and 7. First, the signal on RowSel line drops low. The global AB1 line is pulsed, and when the pulse disapplies a first integration period Integrationl is initiated on all pixels 110 connected to line AB1. Subsequently, AB2 is pulsed, and when the pulse disapplies a second integration period Integration2 is initiated on all pixels 110 connected to line AB2. At some time later all integration periods are ended by a pulse on the TX line connected to all pixels 110. Accordingly, two separate integration periods are provided.

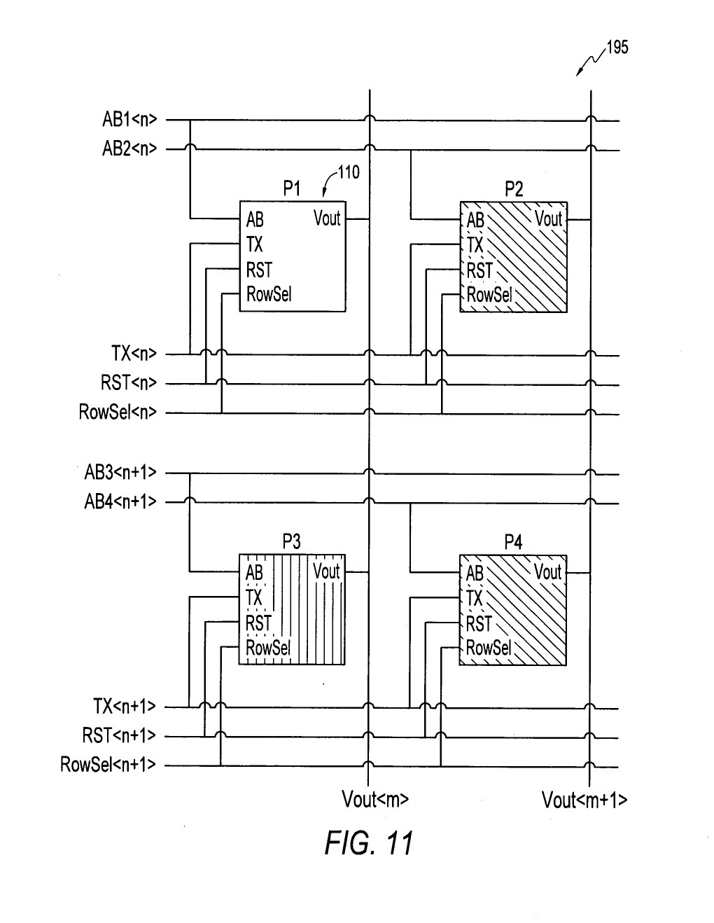

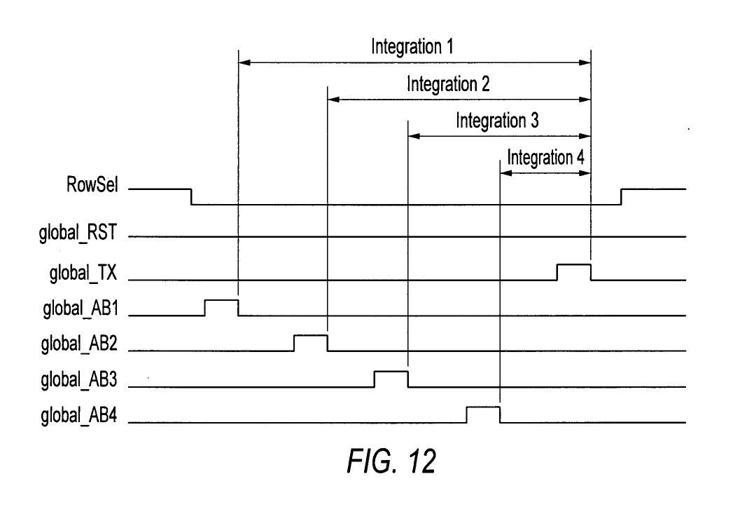

The anti-blooming pixel 110 embodiment may be implemented to provide more than two integration periods. FIG. 11 shows an array 195 configured to support four different integration periods. Anti-blooming transistor 180 (FIG. 8) control line AB1 controls pixel P1 of row(n), control line AB2 controls pixel P2 of row(n), control line AB3 controls pixel P3 of row(n+1) and control line AB4 controls pixel P4 of row(n+1). FIG. 12 shows a global shutter readout timing diagram for the configuration of FIG. 11. As described above, each pulse of global anti-blooming pixel 180 control line (global_AB1, global_AB2 . . . ) initiates an integration period. All integration periods end simultaneously upon the global pulse of the TX signal. Accordingly, at least four different integration periods are possible.

In providing multiple integration periods, the lengths of the integration periods may sequentially increase or sequentially decrease, as shown in FIG. 12, or may be operated to provide equal integration periods, thereby effectively switching to a normal linear mode where global_AB1, global_AB2, global_AB3, and global_AB4 are all pulsed at the same time without the need to change to the pixel or array structure. This same switch to a liner mode of operation may also be implemented in all embodiments described above.

When a readout including multiple integration periods is used, an interpolation algorithm is executed by the image processor 280 (FIG. 1) or another processor in the system controlling the imager 208 to calculate the final value for each pixel. Referring back to FIG. 3, in one embodiment the algorithm assigns the value of the interpolated pixel IP a value equal to the average of the center and right pixel values.

$$\text{Equation 1:}$$

$$IP 8 = \frac{P 8 + P 9}{2}$$

Interpolating pixel values according to Equation 1 provides a way to derive a substantive value for pixels in low light scenes as well as pixels exposed to a high level light scene. Ordinarily when a pixel is exposed to an amount of light that exceeds a saturation level of the pixel, the pixel output is a maximum value without variance beyond the saturation level. Light differentiation and therefore valuable image information is therefore lost at all levels of light beyond the saturation point. This problem is addressed by the embodiment described above. Referring, for example, to FIG. 3, pixel P8 will accumulate charge for an integration period T1 while pixel P9 will accumulate charge for a second integration period T2. For illustrative purposes, assume T1>T2. Providing multiple integration periods T1 and T2 captures an additional set of values in high light scenes where T1 results in saturation while T2, being a shorter integration time, does not result in saturation. Within this set of values, the Equation 1 average of P8 and P9 provides a substantive value for image processing proportionate to the actual local value of the level of light where conventionally only a uniform maximum value is possible. Conversely, in pixels exposed to a low amount of light which is lower than conventional detection levels, a set of values will be captured where T2 results in a value too low for detection while T1, being a longer integration time, results in a detectable value. The dynamic range is thereby increased in scenes of both extreme high and extreme low levels of light simultaneously.

The interpolation algorithms provided are not intended to be limiting. In another embodiment, the interpolated pixel IP is assigned a value equal to the average of the interpolated pixel IP and the average of the upper, lower, left, and right pixel values.

$$\text{Equation 2:}$$

$$IP 8 = ( P 8 + \frac{P 3 + P 7 + P 9 + P 13}{4} ) / 2$$

More sophisticated interpolation algorithms may be implemented based on the above described architecture to enhance different aspects of imaging performance, such as sharpness or signal-to-noise ratio.

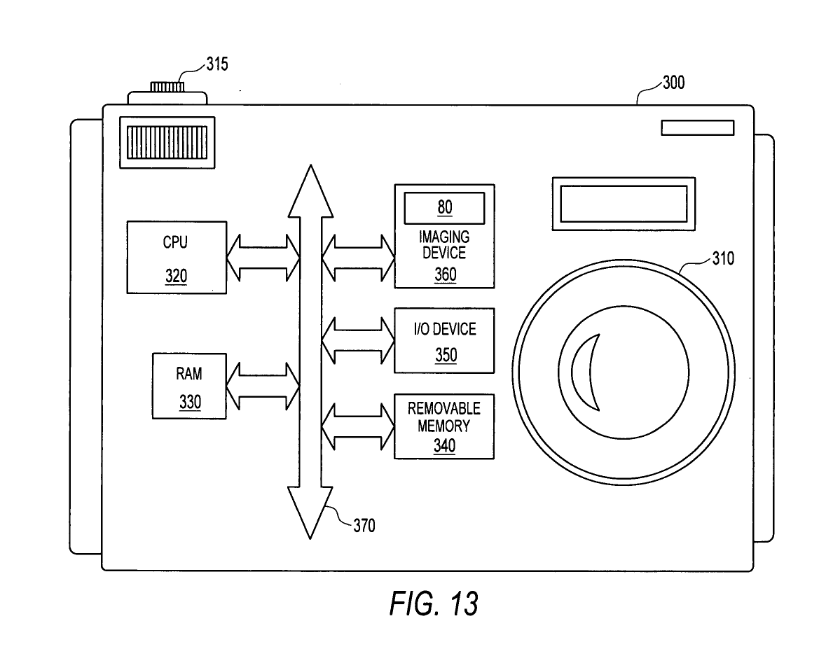

FIG. 13 is a block diagram of a processing system, for example, a camera system 300 having a lens 310 for focusing an image on imaging device 360 when a shutter release button 315 is pressed. Imaging device 360 includes a pixel array 80 constructed in accordance with an embodiment of the present invention. Although illustrated as a camera system the system 300 may also be a computer system, a process control system, or any other system employing a processor and associated memory. The system 300 includes a central processing unit (CPU) 320, e.g., a microprocessor, that communicates with the imaging device 360 and one or more I/O devices 350 over a bus 370. It must be noted that the bus 370 may be a series of buses and bridges commonly used in a processor system, but for convenience purposes only, the bus 370 has been illustrated as a single bus. The processor system 300 may also include random access memory (RAM) device 330 and some form of removable memory 340, such a flash memory card, or other removable memory as is well known in the art.

The above description and drawings illustrate various embodiments of the invention. These embodiments may be modified, changed or altered.

1. An imaging device comprising:
a first pixel in a first row of a pixel array, the first pixel having a first integration period; and a second pixel in the first row of the pixel array, the second pixel having an integration period that is different from the first integration period,
first and second anti-blooming transistors respectively within the first and second pixels and operable to control the first and second integration periods.

2. The device of claim 1, wherein the first integration time period is different from the second integration time period.

3. An imaging device comprising:
a pixel array comprising:
a plurality of pixels arranged in a plurality of rows and columns, each pixel having an anti-blooming transistor for controlling pixel integration time;
a first signal line connected to the anti-blooming transistor of at least one first pixel in each row for operating the at least one first pixel to have a first integration time period; and
a second signal line connected to the anti-blooming transistor of at least one second pixel in each row for operating the at least one second pixel to have a second integration time period.

4. The device of claim 3, wherein the anti-blooming transistor of one half of the pixels of each row are controlled by the first signal line, and the first transistor of the other half of the pixels of each row are controlled by the second signal line.

5. (canceled)

6. (canceled)

7. (canceled)

8. The device of claim 3, further comprising circuitry for executing a rolling shutter readout.

9. The device of claim 3, wherein the first integration time period is different from the second integration time period.

10. The device of claim 3, wherein the first signal line and second signal line are connected to the anti-blooming transistors of pixels in each row forming a pattern wherein pixels having an anti-blooming transistor controlled by the first signal alternate with pixels having an anti-blooming transistor controlled by the second signal in a given row.

11. The device of claim 10, wherein the first signal line and second signal line are connected to the anti-blooming transistor of pixels in each row forming a pattern wherein pixels having an anti-blooming transistor controlled by the first signal alternate with pixels having an anti-blooming transistor controlled by the second signal in a given column.

12. The device of claim 11, wherein a third signal line is connected to the anti-blooming transistor of pixels in each row for applying a signal globally to the anti-blooming transistors.

13. An imaging device comprising:
a pixel array comprising:
a plurality of pixels arranged in a plurality of rows and columns, each pixel having an anti-blooming transistor for controlling pixel integration time;
a first signal line connected to the anti-blooming transistor of at least one first pixel in every other row for operating the at least one first pixel at a first integration time period;
a second signal line connected to the anti-blooming transistor of at least one second pixel in every other row for operating the at least one second pixel at a second integration time period;
a third signal line connected to the anti-blooming transistor of at least one third pixel in every other row for operating the at least one third pixel at a third integration time period; and
a fourth signal line connected to the anti-blooming transistor of at least one fourth pixel in every other row for operating the at least one fourth pixel at a fourth integration time period.

14. (canceled)

15. (canceled)

16. The device of claim 13, wherein the first signal line and the second signal line are both connected to the anti-blooming transistor of pixels in the same rows.

17. The device of claim 13, wherein the third signal line and the fourth signal line are both connected to the first transistor of pixels in the same row.

18. The device of claim 17, wherein the first signal line and the second signal line are connected to the anti-blooming transistor of pixels forming a pattern wherein pixels controlled by the first signal alternate with pixels controlled by the second signal in a given row.

19. The device of claim 18, wherein the third and fourth signal lines are connected to the anti-blooming transistor of pixels forming a pattern wherein pixels controlled by the third signal alternate with pixels controlled by the fourth signal in a given row.

20. The device of claim 19, wherein the first and third signal lines are connected to the anti-blooming transistor of pixels forming a pattern wherein pixels controlled by the first signal alternate with pixels controlled by the third signal in a given column.

21. (canceled)

22. (canceled)

23. (canceled)

24. (canceled)

25. (canceled)

26. (canceled)

27. (canceled)

28. (canceled)

29. (canceled)

30. A pixel array, comprising:
a plurality of pixels arranged in a plurality of rows and columns, each pixel comprising:
a photosensor for collecting photo-generated charge;
a storage region for storing charge; and,
an anti-blooming transistor having a first source/drain terminal connected to a voltage source line and a second source/drain terminal connected to the photosensor;
a first signal line connected to a gate of the anti-blooming transistor in at least a first pixel in each row for controlling a reset of charge accumulated in the photosensor to initiate a first integration time period; and
a second signal line connected to a gate of the anti-blooming transistor in at least a second pixel in each row for controlling a reset of charge accumulated the photosensor to initiate a second integration time period.

31. The pixel array of claim 30, wherein the first signal line and second signal line are connected to the anti-blooming transistors of pixels in each row forming a pattern wherein pixels having an anti-blooming transistor controlled by the first signal line alternate with pixels having an anti-blooming transistor controlled by the second signal line in a given row.

32. The pixel array of claim 30, wherein the first signal line and second signal line are connected to the anti-blooming transistors of pixels in each row forming a pattern wherein pixels having an anti-blooming transistor controlled by the first signal line alternate with pixels having an anti-blooming transistor controlled by the second signal line in a given column.

33. A pixel array, comprising:
a plurality of pixels arranged in a plurality of rows and columns, each pixel comprising:
a photosensor for collecting photo-generated charge;
a storage region for storing charge; and,
an anti-blooming transistor having a first source/drain terminal connected to a voltage source line and a second source/drain terminal connected to the photosensor;
a first signal line connected to a gate of the anti-blooming transistor in at least a first pixel in each row for controlling a reset of charge accumulated in the photosensor to initiate a first integration time period;
a second signal line connected to a gate of the anti-blooming transistor in at least a second pixel in each row for controlling a reset of charge accumulated in the photosensor to initiate a second integration time period.
a third signal line connected to a gate of the anti-blooming transistor in at least a third pixel in each row for controlling a reset of charge accumulated in the photosensor to initiate a third integration time period; and
a fourth signal line connected to a gate of the anti-blooming transistor in at least a fourth pixel in each row for controlling a reset of charge accumulated in the photosensor to initiate a fourth integration time period;

34. The pixel array of claim 33, wherein the first signal line and the second signal line are connected to the anti-blooming transistors of pixels in the same rows.

35. The pixel array of claim 33, wherein the third signal line and the fourth signal line are connected to the anti-blooming transistors of pixels in the same row.

36. The pixel array of claim 35, wherein the first signal line and second signal line are connected to the anti-blooming transistors of pixels forming a pattern wherein pixels controlled by the first signal line alternate with pixels controlled by the second signal line in a given row.

37. The pixel array of claim 36, wherein the third signal line and fourth signal line are connected to the anti-blooming transistors of pixels forming a pattern wherein pixels controlled by the third signal line alternate with pixels controlled by the fourth signal line in a given row.

38. The pixel array of claim 37, wherein the first signal line and third signal line are connected to the anti-blooming transistors of pixels forming a pattern wherein pixels controlled by the first signal line alternate with pixels controlled by the third signal line in a given column.

39. A method of operating a pixel array having a plurality of pixels arranged in a plurality of rows and columns, the method comprising:
initiating a first charge integration period for a first subset of pixels;
initiating a second charge integration period for a second subset of pixels;
initiating a third charge integration period for a third subset of pixels;
initiating a fourth charge integration period for a fourth subset of pixels, and
transferring accumulated charge from all pixels for readout;
wherein the first, second, third, and fourth subsets of pixels are exclusive.

40. The method of claim 39, wherein a length of the first integration time period is different from a length of the second integration time period.

41. The method of claim 39, where a length of the first integration time period is equal to a length of the second integration time period.

42. The method of claim 39, further comprising determining a pixel output value based upon an average of the pixel value and at least one adjacent pixel value.

43. (canceled)

44. The method of claim 39, wherein a length of third integration time period is different from a length of the fourth integration time period.

45. The method of claim 39, where the length of the third integration time period is equal to the length of the fourth integration time period.

46. The method of claim 39, where the lengths of the first, second, third, and fourth integration time periods are equal.

47. The method of claim 39, wherein lengths of the first, second, third, and fourth integration time periods are different from each other.

48. The method of claim 47, further comprising determining a pixel output value based upon an average of the pixel value and at least one adjacent pixel value.

49. The method of claim 39, where the lengths of the first, second, third, and fourth integration time periods progressively increase with respect to each other.

50. The method of claim 39, where the lengths of the first, second, third, and fourth integration time periods are progressively decrease with respect to each other.

51. The method of claim 39, further comprising determining a pixel output value based upon an average of the pixel value and at least one adjacent pixel value.

52. A processing system, comprising:
a processor; and
an imaging device coupled to the processor, the imaging device comprising:
a pixel array, comprising:
a plurality of pixels arranged in a plurality of rows and columns, each pixel comprising:
an anti-blooming transistor;
a first signal line connected to the first transistor of at least one first pixel in each row for operating the at least one first pixel to have a first integration time period; and
a second signal line connected to the first transistor of at least one second pixel in each row for operating the at least one second pixel to have a second integration time period.

53. A camera system, comprising:
a processor; and
an imaging device coupled to the processor, the imaging device comprising:
a plurality of pixels arranged in a plurality of rows and columns, each pixel having an anti-blooming transistor;
a first signal line connected to the anti-blooming transistor of at least one first pixel in every other row for operating the at least one first pixel at a first integration time period;
a second signal line connected to the anti-blooming transistor of at least one second pixel in every other row for operating the at least one second pixel at a second integration time period;
a third signal line connected to the anti-blooming transistor of at least one third pixel in every other row for operating the at least one third pixel at a third integration time period; and
a fourth signal line connected to the anti-blooming transistor of at least one fourth pixel in every other row for operating the at least one fourth pixel at a fourth integration time period.

54. The camera system of claim 53, wherein the first signal line and the second signal line are connected to the anti-blooming transistor of pixels forming a pattern wherein pixels controlled by the first signal alternate with pixels controlled by the second signal in a given row.

55. The camera system of claim 54, wherein the third and fourth signal lines are connected to the anti-blooming transistor of pixels forming a pattern wherein pixels controlled by the third signal alternate with pixels controlled by the fourth signal in a given row.

56. The camera system of claim 55, wherein the first and third signal lines are connected to the anti-blooming transistor of pixels forming a pattern wherein pixels controlled by the first signal alternate with pixels controlled by the third signal in a given column.
